(19) United States
(12) Patent Application Publication
(10) Pub. No.: US 2025/0314072 A1
(43) Pub. Date: Oct. 9, 2025

(54) LOUVER BLADE, LOUVERED ROOF, AND VIEWING SHELTER

(71) Applicant: ZHEJIANG GRAND LEISURE OUTDOOR PRODUCTS CO., LTD., Huzhou (CN)

(72) Inventors: Ren LI, Richmond (CA); Bo LIU, Huzhou (CN)

(73) Assignee: ZHEJIANG GRAND LEISURE OUTDOOR PRODUCTS CO., LTD., Huzhou (CN)

(21) Appl. No.: 18/940,877

(22) Filed: Nov. 8, 2024

(30) Foreign Application Priority Data
Apr. 3, 2024 (CN) 202410403418.0

(51) Int. Cl. E04F 10/10

(52) U.S. Cl. CPC E04F 10/10

(57) ABSTRACT

Provided are louver blade, louvered roof, and viewing shelter. Drainage groove is arranged on one side of body of louver blade; and includes groove wall located on outer side of body. Baffle plate is arranged on top of groove wall. When body is arranged horizontally, top end of groove wall is not higher than top surface of louver blade. Baffle plate can switch between natural and stressed states. Top end of baffle plate in natural state is higher than top end of groove wall, and has height that can be reduced in stressed state. Louvered roof includes shelter frame and multiple louver blades. When multiple louver blades are closed on shelter frame, other side of one louver blade relative to drainage groove presses against baffle plate of adjacent louver blade. Baffle plate switches to stressed state. When louver blades rotate to open, baffle plate switches to natural state.

### CROSS-REFERENCE TO RELATED APPLICATION

The present disclosure claims priority to Chinese patent application No. 2024104034180, filed with the Chinese Patent Office on Apr. 3, 2024, the entire contents of which are incorporated herein by reference.

### TECHNICAL FIELD

The disclosure relates to the field of roofs (ceilings, shelter roofs), and specifically to a louver blade, a louvered roof, and a viewing shelter.

### BACKGROUND ART

As a new type of shelter, a louvered shelter is mainly consisted of a shelter frame and a plurality of louver blades linearly distributed on the shelter frame, wherein the plurality of louver blades rotate simultaneously by a linkage mechanism, so that the roof can be in an open state when the louver blades are tilted, and generally the roof can be in a closed state when the louver blades are arranged horizontally. The louvered shelter is commonly used in the viewing shelter, folding shelter, and some other outdoor furniture due to its convenience in use.

At present, when the louvered shelter switches from the closed state to the open state, if water remains on the surface of the louver blades, the water is easy to drip into the room along the tilted louver blades, which results in a relatively poorer experience for the user.

### SUMMARY

The object of embodiments of the present disclosure is to provide a louver blade, a louvered roof, and a viewing shelter, which can reduce dripping water when the louver blade rotates to open, so as to improve the user experience.

In a first aspect, the embodiments of the present disclosure provide a louver blade including a flaky body, wherein a drainage groove is arranged on one side of the body; the drainage groove includes a groove wall located on an outer side of the body; and a baffle plate is further arranged on a top of the groove wall, wherein when the body is arranged horizontally, a top end of the groove wall is not higher than a top surface of the louver blade, and the baffle plate can switch between a natural state and a stressed state, wherein a top end of the baffle plate in the natural state is higher than the top end of the groove wall, and a height of the top end of the baffle plate can be reduced in the stressed state.

The drainage groove is arranged one side of the louver blade, and the baffle plate is further arranged on the top of the groove wall. When the louver blade rotates to the open state towards a direction of the drainage groove, the louver blade is not pressed by other louver blades at this time, and the baffle plate on the louver blade is in the natural state. The top end of the baffle plate is higher than the top end of the groove wall to heighten the groove wall; and the water remaining on the top surface of the louver blade can flow into the drainage groove under the blocking action of the baffle plate, which reduces chances of the water droplet falling to a bottom (indoor) of the louver blade, and plays a drip-proof role, so as to improve the user experience.

When a plurality of louver blades are arranged side by side in a closed state, the louver blades can be arranged horizontally at this time. The baffle plate on the outer side of the louver blades can switch into a stressed state under the pressure of adjacent louver blades, so as to reduce the height of the top end of the baffle plate, so that the adjacent louver blade overlaps on this position to form a flat louver blade top surface. Since the top end (a height of the opening of the drainage groove) of the groove wall of the louver blade is not higher than the top surface of the louver blade, the water (which is mainly rainwater, but can also be water produced by washing the top surface of the louver blade) on the top surface of the louver blade will concentrate on flowing to a drainage groove with a lower position, so as to achieve the centralized collection and the discharge of water flow. Additionally, even if a water storage capacity of the drainage channel reaches a full state, the water in the drainage groove is difficult to intrude onto the top surface of the louver blade, so that it can effectively reduce chances that the solar panel or other components are immersed by water when the top surface of the louver blade is provided with the solar panel or other components, so as to effectively protect the components.

In one possible embodiment, the baffle plate is an elastic baffle plate, and the elastic baffle plate can deform to reduce a height of its top end in a stressed state. The elastic baffle plate plays a role of drip-proof in a natural state; the elastic baffle plate can deform in a stressed state to reduce its size along a thickness direction of the body, so as to reduce the height of its top end; and the elastic baffle plate can be snapped between the adjacent louver blades after deformed, so as to play a sealing role.

In one possible embodiment, a sectional shape of the elastic baffle plate is linear or annular in a natural state. The elastic baffle plates have diverse sectional shapes in the natural state. These elastic baffle plates can not only play a drip-proof role when the louver blades open, but also are easily pressed and deformed when the louver blades rotate, so that the louver blades are not affected until rotating to the closed state.

In one possible embodiment, an installation position of the elastic baffle plate on the groove wall is on an inside, a top or an outside of the groove wall. The installation position of the elastic baffle plate can be flexibly selected according to the actual situation.

In one possible embodiment, a bottom end of the elastic baffle plate is snapped or bonded to the groove wall; and/or, the elastic baffle plate passes through the groove wall. The installation method of the elastic baffle plate can be flexibly selected according to the actual situation.

In one possible embodiment, a material of the elastic baffle plate includes at least one of rubber, silicone, PVC, elastomer TPE, TPR plastic, and polyurethane. The selection ranges of the material of the elastic baffle plate are broad. They have a certain elasticity, wherein in the natural state, they can remain in the natural state to catch dripping water, and they are easily stressed to deform to the stressed state and to return to the natural state.

In one possible embodiment, the baffle plate is a hard baffle plate, and the hard baffle plate is hinged to the groove wall, wherein the hard baffle plate can rotate around a hinge position under a stressed state to reduce a height of its top end; and the hard baffle plate can switch to a natural state when the louver blade rotates towards one side of the drainage groove. The hard baffle plate plays the drip-proof role in the natural state, and the hard baffle plate is easy to switch to the stressed state.

In one possible embodiment, the hard baffle plate is arranged on the top end of the groove wall, and is hinged to the top end of the groove wall. The hard baffle plate is easy to install and can rotate, thereby reducing the impact on the drainage groove.

In one possible embodiment, the hard baffle plate can switch to the natural state under an action of gravity when the louver blade rotates towards one side of the drainage groove; or, a reset member is arranged between the hard baffle plate and the body, and the hard baffle plate can switch to the natural state under an action of the reset member. The elastic baffle plate is easy to restore to the natural state, so as to play the drip-proof role.

In one possible embodiment, the baffle plate is the hard baffle plate; the hard baffle plate is connected to the drainage groove by a reset member; and the hard baffle plate can move in its height direction to reduce the height of its top end under the stressed state, wherein the reset member can drive the hard baffle plate to switch to the natural state. The hard baffle plate has little effect on the structure of the drainage groove, and the hard baffle plate plays the role of drip-proof in the natural state.

In one possible embodiment, the hard baffle plate passes through the groove wall, and a bottom end of the hard baffle plate extends into the drainage groove and is connected to the drainage groove by the reset member. The hard baffle plate is easy to install and arrange, and the stability of state switching is good.

In one possible embodiment, the top of the groove wall has a flange extending toward an interior of the drainage groove, and the baffle plate is arranged on the flange or adjacent to the baffle plate. The flange can cover partial opening of the drainage groove, which reduces a problem that the water flows out of the drainage groove since the water in the drainage groove is too turbulent, so as to play the effect of waterproofing and stabilizing the flow. The flange facilitates the installation and arrangement of the baffle plate at this position, and can provide a certain support for the baffle plate arranged at this position.

In one possible embodiment, the flange is arranged horizontally or tends to warp upwardly towards its free end. The flange tends to warp upwardly towards its free end, which can provide a side edge of the adjacent louver blade with a space to avoid and return; and its warping flange can cooperate with the side edge (which specially can be a bent waterproof edge) of the adjacent louver blade, so that the structure is more compact after the combination of the adjacent louver blades under the premise that the rotation between the adjacent louver blades will not affect each other, which can also reduce a gap at the connection position, and reduce the possibility that the rainwater enters the shelter through the gap between the flange and the side edge (which specially can be the bent waterproof edge) of the adjacent louver blade, so as to improve the waterproof sealing performance between louver blades.

In one possible embodiment, a downwardly extending waterproof edge is arranged on the other side of the body relative to the drainage groove, and a bottom end of the waterproof edge is lower than the top end of the groove wall, wherein the waterproof edge of the louver blade can press the baffle plate of the adjacent louver blade and switch it to the stressed state. The waterproof edge increases the return space of adjacent louver blades in synchronous rotation, which avoids the interference between the waterproof edge and the groove wall of adjacent louver blades, thereby affecting the normal rotation of them. When the louver blades rotate to close, the waterproof edge of the adjacent louver blade is easy to press the baffle plate, so as to switch to the stressed state.

In one possible embodiment, a position of a lower surface of the body close to the waterproof edge and/or an upper surface of the flange is provided with a sealing strip. It can paste and seal the gap between adjacent louver blades when the louver blades rotate to the closed state, so as to improve the waterproof sealing performance between louver blades. In case that the sealing strip cooperates with the elastic baffle plate, it can further play a double sealing role, which further improves the waterproof sealing performance between the louver blades.

In one possible embodiment, a lower surface of the body close to the waterproof edge is provided with a snapping groove, wherein the snapping groove extends along a length direction of the body, and the sealing strip is snapped into the snapping groove. The sealing strip is easily snapped by the snapping groove, and it also facilitates the removal and replacement for the sealing strip.

In one possible embodiment, the top end of the baffle plate in the natural state is higher than a same-side edge of the top surface of the louver blade. Optionally, the top end of the baffle plate in the natural state is 1-50 mm higher than the same-side edge of the top surface of the louver blade. The top end of the baffle plate is higher than the same-side edge of the top surface of the louver blade can better perform the drip-proof effect. When the louver blade rotates toward the drainage groove, the raised baffle plate can catch the water dripping down from the top surface of the louver blade, and guide it to flow into the drainage groove.

In one possible embodiment, a top end surface of the baffle plate in the natural state is flush to the same-side edge of the top surface of the louver blade, or the top end of the baffle plate in the natural state is lower than the same-side edge of the top surface of the louver blade. Optionally, the top end of the baffle plate in the natural state is 0-3 mm lower than the same-side edge of the top surface of the louver blade. When the louver blade rotates in a specific range of angle towards the direction of the drainage groove, the baffle plate can still play the drip-proof effect to catch the water dripping from the top surface of the louver blade.

In one possible embodiment, a tilt angle of the baffle plate in the natural state relative to the top surface of the louver blade is 45°-100°. Optionally, a tilt angle of the baffle plate in the natural state relative to the top surface of the louver blade is 60°-90°. The elastic baffle plate is tilted at a certain angle relative to the horizontally arranged body (the louver blade), which not only can play the role of drip-proof, but also when the louver blade simultaneously rotates to the closed state, the baffle plate on the adjacent louver blade is easily pressed by this louver blade to switch to the stressed state, and therefore the closing effect between the adjacent louver blades is not affected.

In one possible embodiment, the body is made of a metal sectional material, and its section is a frame structure. Optionally, the frame structure is provided with a broken bridge structure therein. The section is made of the metal sectional material of the frame structure, which has advantages of a lower quality and higher strength. It is suitable for the formation of the roof and facilitates the arrangement of the drainage groove. The body with the broken bridge structure has good thermal insulation performance, and reduces the heat conduction between indoors and outdoors by the body.

In one possible embodiment, a bottom of one side of the body extends outwardly to form a groove bottom; the groove bottom bends and extends upwardly to form a groove wall; the body, the groove bottom, and the groove wall form the drainage groove together; the drainage groove has a flow guide opening with an opening facing upward; and the flow guide opening is not higher than the top surface of the body.

In one possible embodiment, a maximum length of the baffle plate that can extend into the drainage groove in a stressed state is not larger than a width of a narrowest position in the drainage groove. When the plurality of louver blades simultaneously rotate to the closed state, the baffle plate can be pressed by the adjacent louver blade and extend into the drainage groove. The baffle plate extending into the drainage groove can be taken as a structure to block the water flow in the drainage groove, and plays role of blocking the water flow in the drainage groove from rushing out together with the waterproof edge at this position. The maximum length of the baffle plate that can extend into the drainage groove is not larger than the width of the narrowest position in the drainage groove, so as to ensure that the baffle plate can go out of the drainage groove and return to the natural state to play the role of drip-proof when the louver blade rotates to the open state.

In one possible embodiment, the width of the narrowest position in the drainage groove is 20-100 mm, optionally 30-50 mm.

In one possible embodiment, the top end of the baffle plate in the natural state is 5-80 mm higher than the top end of the groove wall, optionally 20-30 mm.

In one possible embodiment, the baffle plate is arranged continuously or intermittently along a length direction of the body. The arrangement form and length of the baffle plate can be provided according to the drip-proof requirements of the louver blade.

In one possible embodiment, a top surface of the body is a continuous surface, and the top surface of the louver blade is consisted of the continuous surface. In case that a solar panel is not provided, as the top surface of the louver blade, the continuous surface of the body can discharge the water on the top surface in time, which avoids the accumulated water generated by sunken of the top surface of the body.

In one possible embodiment, a solar panel is further installed and arranged on the body, and the top surface of the louver blade is consisted of an upper surface of the solar panel. As for the arrangement condition of the solar panel, the louver blade formed by the solar panel arranged on the body can be taken as a solar-power generating part to improve energy utilization.

In one possible embodiment, the body is provided with a holding groove for installing the solar panel, and the solar panel is snapped into the holding groove; or, the solar panel is detachably installed on the body by a fastener. The holding groove is provided to facilitate the snapping installation for the solar panel. Alternatively, the solar panel can be directly installed on the body, so as to improve the utilization of the solar panel.

In a second aspect, the embodiments of the present disclosure provide a louvered roof including a shelter frame and a plurality of louver blades provided in the first aspect, wherein two ends of the louver blade are rotationally connected within the shelter frame respectively, and the plurality of louver blades are distributed side by side on the shelter frame, wherein when the plurality of louver blades is in a closed state on the shelter frame, the other side of one of the louver blades relative to the drainage groove presses against the baffle plate of the adjacent louver blade, so that the baffle plate switches to the stressed state; and when the louver blades rotate to an open state, the baffle plate of the louver blade switches into the natural state.

When the plurality of louver blades are in the closed state, they can serve as a roof for protection. When the louver blades are in the open state, they can play a role of ventilation; and the water on the top surface of the louver blades will not directly drip down by utilizing the drip-proof effect of the baffle plate in the natural state, but flow into the drainage groove, thereby improving the user experience.

In one possible embodiment, the downwardly extending waterproof edge is arranged on the other side of the body of the louver blade relative to the drainage groove, wherein when the louver blade is arranged horizontally, the bottom end of the waterproof edge is lower than the top end of the groove wall; and when the plurality of louver blades are in a closed state, the waterproof edge of one of the louver blades is correspondingly inserted into the drainage groove of the adjacent louver blade. When the plurality of louver blades are in the closed state, the waterproof edge is inserted into the drainage groove of the adjacent louver, and the waterproof edge is used to block the flow water in the drainage groove.

In one possible embodiment, the baffle plate is an elastic baffle plate, wherein when the plurality of louver blades are in the closed state, the other side of one of the louver blades relative to the drainage groove presses against the elastic baffle plate of the adjacent louver blade, so that the elastic baffle plate extends into the drainage groove. When the plurality of louver blades are in the closed state, the elastic baffle plate is deformed and inserted into the drainage groove of the adjacent louver blade, so as to play a better sealing effect by utilizing the deformed elastic baffle plate.

In one possible embodiment, the louvered roof further includes a linkage mechanism, and the linkage mechanism includes a linear telescopic rod and a linkage bar, wherein one ends of the plurality of louver blades are hinged to the linkage bar; one end of the linear telescopic rod is hinged to the shelter frame; and the other end is hinged to the linkage bar, so as to drive the plurality of louver blades to rotate around hinge points of the louver blades and the shelter frame after actuating the linkage bar to move. When the linear telescopic rod moves telescopically, the movable bar is driven to move, and the plurality of louver blades are hinged to the movable bar. Meanwhile, the louver blades are also rotationally connected to the shelter frame, so that when the linkage bar moves, the plurality of louver blades will be driven to rotate simultaneously, and therefore the louver blades switch between the open state and the closed state.

In one possible embodiment, a drainage channel is arranged below same ends of all the louver blades, and the drainage channel is provided with a water collecting opening towards the ends of the louver blades. The drainage channel is used to further converge and collect the rainwater converging from the top surface of the louver blades into the drainage groove, and then discharge the rainwater.

In a third aspect, the embodiments of the present disclosure provide a viewing shelter including columns and the louvered roof provided in the second aspect, wherein the louvered roof is arranged on a top of the columns. The louvered roof of the viewing shelter has the drip-proof function, which reduces the dripping water when the louver blades rotate to open, so as to improve the user experience.

### BRIEF DESCRIPTION OF DRAWINGS

In order to more clearly illustrate the technical solutions in the embodiments of the present disclosure, the drawings to be used in the embodiments of the present disclosure will be briefly introduced below. It should be understood that the following drawings only show certain embodiments of the present disclosure, and therefore should not be regarded as a limitation of the scope. For a person of ordinary skill in the art, other relevant drawings can be obtained according to these drawings without inventive efforts.

FIG. 1 shows a structure schematic diagram of a louver blade provided by an embodiment of the present disclosure;

FIG. 2 shows a structure schematic diagram of a louver blade in a closed state shown in FIG. 1;

FIG. 3 shows an enlarged structure schematic diagram of part A in FIG. 2;

FIG. 4 shows a structure schematic diagram of a louver blade in an open state shown in FIG. 1;

FIG. 5 shows a structure schematic diagram of a louver blade provided by another embodiment of the present disclosure;

FIG. 6 shows a structure schematic diagram of a louver blade in a closed state shown in FIG. 5;

FIG. 7 shows an enlarged structure schematic diagram of part A in FIG. 6;

FIG. 8 shows a structure schematic diagram of a louver blade in an open state shown in FIG. 5;

FIG. 9 shows a structure schematic diagram of a louver blade provided by another embodiment of the present disclosure;

FIG. 10 shows a structure schematic diagram of a louver blade provided by another embodiment of the present disclosure;

FIG. 11 shows a structure schematic diagram of a louver blade provided by another embodiment of the present disclosure;

FIG. 12 shows a structure schematic diagram of a louver blade provided by another embodiment of the present disclosure;

FIG. 13 shows a structure schematic diagram of a louver blade provided by another embodiment of the present disclosure;

FIG. 14 shows a structure schematic diagram of a louver blade provided by another embodiment of the present disclosure;

FIG. 15 is a structure schematic diagram of a viewing shelter provided by another embodiment of the present disclosure;

FIG. 16 shows a disassembled structure schematic diagram of a viewing shelter in FIG. 15;

FIG. 17 shows an installation structure schematic diagram of beams and columns in FIG. 15;

FIG. 18 shows a structure schematic diagram of a flow guide member in FIG. 17;

FIG. 19 shows an installation structure schematic diagram of a louver blade and a beam in FIG. 15; and

FIG. 20 shows a structure schematic diagram of a beam in FIG. 19.

Reference numbers: 110—column; 1101—second flow guide opening; 1102—screw hole; 1103—pre—connector; 111—reinforcing member; 112—end cover; 120—beam (cross beam); 1201—side frame; 1201a—second snap—fit groove; 1201b—fitting foot; 120a—long beam; 120b—short beam; 121—beam cover; 121a—first snapping head; 121b—second snapping head; 122—extension frame; 122a—axis hole; 1221—cabling groove; 1222—preconnected cavity; 1223—first snap—fit groove; 130—drainage channel; 1301—third snapping head; 1301a—bending head part; 1301b—abutting part; 1302—first insertion member; 131—flow guide member; 1310—second insertion member; 1311—filter gate; 1312—first flow guide opening; 140—linear telescopic rod; 141—linkage bar; 200—air conditioner; 300—louver blade; 3000—body; 300a—frame body; 300b—first extension edge; 300c—second extension edge; 301—waterproof edge; 302—groove wall; 303—flange; 304—snapping groove; 310—solar panel; 320—sealing plate; 330—plug; 331—elastic member; 340—elastic baffle plate; 350—first louver blade; 360—second louver blade; 370—hard baffle plate; and 380—reset member.

### DETAILED DESCRIPTION OF EMBODIMENTS

The louvered roof is generally consisted of a plurality of louver blades that are arranged side by side and can rotate individually. When the louvered roof is in a closed state, one side of one louver blade needs to overlap on a drainage groove on one side of the adjacent louver blade, so as to form a closed roof structure. The opening of the drainage groove is usually lower than an upper surface of the roof structure, so that the water on a surface of the roof structure smoothly flows into the drainage groove. However, when the louver blades of this structure rotate and open towards one side of the drainage groove, the louver blades will tilt in a direction of the drainage groove, and the position of the drainage groove becomes lower. If there is water on the surface of the louver blades, the water is easy to flow along the surface, and crosses the drainage groove at a lower position and drips down directly, i.e., the phenomenon of dripping water occurs.

In order to reduce the chance of dripping water, the structure of the louver blades needs to be designed to improve its drip-proof function.

The technical solutions in the embodiments of the present disclosure will be described below in conjunction with the drawings in the embodiments of the present disclosure.

In order to make the purpose, technical solutions, and advantages of the embodiments of the present disclosure clearer, the technical solutions in the embodiments of the present disclosure will be described clearly and completely as follows in conjunction with drawings in the embodiments of the present disclosure. It is clear that the embodiments described are only partial embodiments of the present disclosure, and not all of the embodiments. The components in embodiments of the present disclosure generally described and shown in the drawings herein may be arranged and designed in various different configurations.

In the description of the present disclosure, the term “and/or” is merely an associative relationship describing an associated object, which indicates that three relationships may exist, e.g., A and/or B may represent three cases: A alone, both A and B, and B alone. Additionally, the character “/” in the specification generally indicates that before and after associated objects have an “or” relationship.

In the description of the present disclosure, the term “plurality” refers to more than two (including two), and similarly, “plurality of groups” refers to more than two (including two) groups, and “plurality of plates” refers to more than two (including two) plates.

In the description of the present disclosure, it should be noted that orientations or positional relationships indicated by terms, such as “center”, “up”, “down”, “left”, “right”, “vertical”, “horizontal”, “inside”, and “outside”, etc., are the orientations or positional relationships based on the drawings, or the orientation or positional relationship that the product of the present disclosure is customarily placed in use. They are only used to facilitate the description of the present disclosure and simplify the description, and are not to indicate or imply that the device or component referred to must have a particular orientation, or be constructed and operated with a particular orientation, and therefore cannot to be understood as limitations of the present disclosure. Additionally, the terms “first”, “second”, “third”, etc., are used only to distinguish descriptions, and are not to be understood as indicating or implying a relative importance.

Additionally, the terms “horizontal”, “vertical”, “overhanging”, etc. do not mean that the component must be absolutely horizontal or overhanging, but can be slightly inclined, e.g., “horizontal” only refers that it is more horizontal than “vertical” and does not mean that the structure must be absolutely horizontal, but can be slightly inclined.

In the description of the present disclosure, it should also be noted that unless other expressly specifications and limitations, the terms “arrange”, “mount”, “connect”, and “link” are to be understood in a broad sense, e.g. it can be a fixed connection, a detachable connection, or an integral connection; it can be a mechanical connection or an electrical connection; and it can be a direct connection, an indirect connection through an intermediate medium, or a communication inside two components. For a person of ordinary skill in the art, the specific meaning of the above terms in the present disclosure may be understood in specific situations.

### Embodiment 1

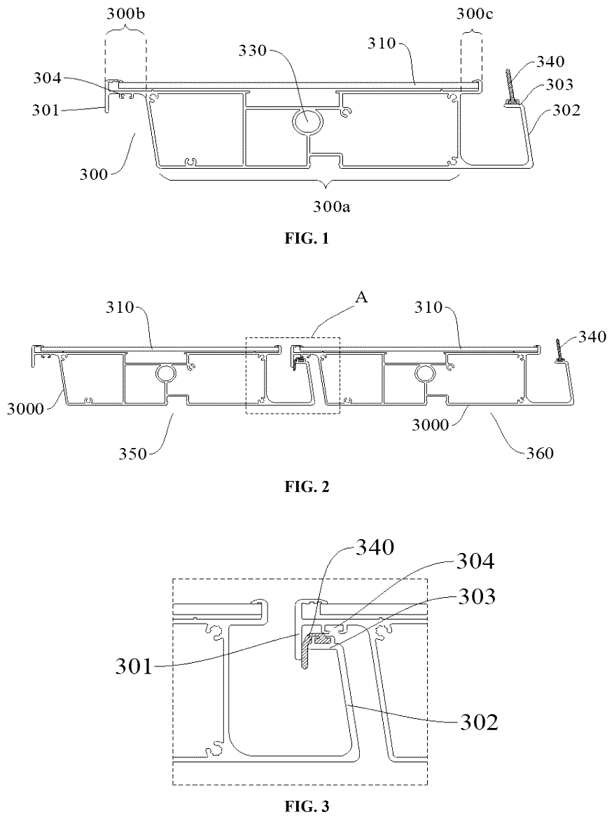

Referring to FIG. 1-FIG. 4, the embodiment of the present disclosure provides a louver blade 300 including a flaky body 3000, wherein a drainage groove is arranged on one side of the body 3000; the drainage groove includes a groove wall 302 arranged on an outer side of the body 3000; and a baffle plate is further arranged on a top of the groove wall 302, wherein when the body 3000 is arranged horizontally, a top end of the groove wall 302 is not higher than a top surface of the louver blade 300, and the baffle plate can switch between a natural state and a stressed state, wherein a top end of the baffle plate in the natural state is higher than the top end of the groove wall 302, and a height of the top end of the baffle plate can be reduced in the stressed state.

In the embodiment of the present disclosure, the louver blade 300 (the body 3000) is arranged horizontally, which means that the top surface (the surface facing upward) of the louver blade 300 is in a horizontal state or close to the horizontal state. For example, in case that the middle part of the top surface of the louver blade 300 is a flat surface (the top surface is mainly consisted of the upper surface of the body 3000 or of the upper surface of the solar panel 310), the louver blade 300 (the body 3000) is arranged horizontally, which means that the flat surface is in the horizontal state; or in case that the top surface of the louver blade 300 is an arcuate surface projecting upwardly at the middle part, the louver blade 300 (the body 3000) is arranged horizontally, which means that the middle part is in the highest position. The tilted arrangement for the louver blade 300 (body 3000) is compared to the horizontal arrangement, and it generally refers to a state after rotating a certain angle around a rotation shaft arranged in a length direction from the horizontal arrangement state.

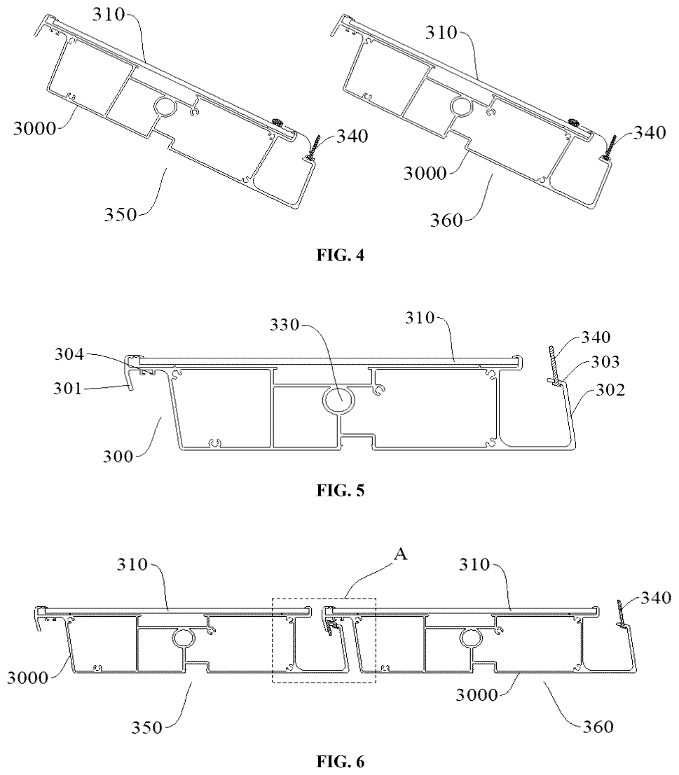

In the embodiment of the present disclosure, the horizontal arrangement for the louver blade 300 (the body 3000) is not limited to the arrangement state after installation. Since the louver blade 300 can rotate around the rotation shaft arranged in the length direction after installation, the arrangement state of the louver blade 300 after installation is changeable. For ease of illustration, the installed louver blade 300 can have a closed state and an open state. When the louver blade 300 is in the closed state, the louver blade 300 is usually arranged horizontally, or can be slightly tilted toward one side or tilted toward one end, wherein the edge of the louver blade 300 and the edge of the adjacent louver blade 300 are overlapped each other to form a closed roof structure (shown in FIG. 2). The louver blade 300 in the closed state rotates toward one side (generally one side towards the drainage groove) by a certain range of angles, so that the louver blade 300 is in the open state. The louver blade 300 in the open state is tilted, and the adjacent louver blades 300 are arranged at intervals (shown in FIG. 4).

For the shape design of the louver frame (the body 3000) itself, unless otherwise specified, “top end” in the embodiments of the present disclosure refers to a vertex position of the louver blade 300 (the body 3000) when it is arranged horizontally, e.g., the top end of the groove wall 302 refers to a vertex of the groove wall 302 when the louver blade 300 (the body 3000) is arranged horizontally. The height of a position refers to a height of the louver blade 300 (the body 3000) relative to a reference plane below the louver blade 300 (the body 3000) when it arranged horizontally, e.g., the top end of the groove wall 302 is not higher than the top surface of the louver blade 300, which refers to that the top end of the groove wall 302 is lower than or flush to any position on the top surface of the louver blade 300 when the louver blade 300 (the body 3000) is arranged horizontally. Compared to the natural state, the height of the top end of the baffle plate can be reduced under the stressed state, and the height of the top end of the baffle plate in the stressed state is smaller than the height in the natural state.

The baffle plate is arranged on the top end of the groove wall 302, which means that at least partial baffle plate is located on the top end of the groove wall 302, so that the top end of the baffle plate in the natural state is higher than the top end of the groove wall 302. The state of the baffle plate has the natural state and the stressed state. The natural state is a state when the baffle plate is not stressed by an external force, which is also referred to as a non-stressed state, and the baffle plate in the natural state is higher than the top end of the groove wall 302. The height of the top end of the baffle plate in the stressed state is reduced, and the opening of the drainage groove is not blocked completely, so that the water-collecting effect of the drainage groove is not affected. In the embodiment of the present disclosure, when the louver blade 300 is in the open state, the louver blade 300 is tilted; the adjacent louver blades 300 are arranged on one end at intervals; and the baffle plate on the louver blade 300 is in the natural state. When the louver blade 300 is in the closed state, the adjacent louver blades 300 are overlapped together, and the baffle plate on the louver blade 300 is in the stressed state.

In some embodiments of the present disclosure, the baffle plate is an elastic baffle plate 340, wherein the top end of the elastic baffle plate 340 in the natural state is higher than the top end of the groove wall 302, and it can deform to reduce the height of the top end in the stressed state, wherein the elastic baffle plate 340 can meet at least one of the following conditions.

In some embodiments of the present disclosure, referring to FIG. 1, the top end of the elastic baffle plate 340 in the natural state is higher than the same-side edge of the top surface of the louver blade 300. The same-side edge of the top surface of the louver blade 300 refers to the position of the top surface of the louver blade 300 close to one side of the elastic baffle plate 340, which is lower than the elastic baffle plate 340 in the natural state, so that the water on the top surface of the louver blade 300 flows smoothly into the drainage groove along the edge, so as to realize collection and centralized drainage for the rainwater.

In specific embodiments, the top end of the elastic baffle plate 340 in the natural state is 1-50 mm higher than the same-side edge of the top surface of the louver blade 300. Exemplarily, the top end of the elastic baffle plate 340 is higher than the same-side edge of the top surface of the louver blade 300 by 1 mm, 3 mm, 10 mm, 20 mm, 30 mm, 40 mm, 50 mm, or an intermediate value between any two values.

In other embodiments of the present disclosure, the top end surface of the baffle plate in the natural state can also be flush with the same-side edge of the top surface of the louver blade 300, or the top end of the baffle plate in the natural state is lower than the same-side edge of the top surface of the louver blade 300.

In specific embodiments, the top end of the baffle plate in the natural state is 0-3 mm lower than the same-side edge of the top surface of the louver blade 300. Exemplarily, the top end of the baffle plate is flush to the same-side edge of the top surface of the louver blade 300, or the top end of the baffle plate is lower than the same-side edge of the top surface of the louver blade 300 by 1 mm, 2 mm, 3 mm, or an intermediate value between any two values.

In some embodiments of the present disclosure, the top end of the elastic baffle plate 340 in the natural state is 5-80 mm higher than the top end of the groove wall 302, optionally 20-30 mm. Exemplarily, the top end of the elastic baffle plate 340 in the natural state is higher than the top end of the groove wall 302 by 5 mm, 20 mm, 30 mm, 40 mm, 50 mm, 60 mm, 80 mm, or an intermediate value between any two values.

In some embodiments of the present disclosure, a tilt angle of the elastic baffle plate 340 in the natural state relative to the top surface of the louver blade 300 is 45°-100°. Optionally, the tilt angle of the elastic baffle plate 340 in the natural state relative to the top surface of the louver blade 300 is 60°-90°. Exemplarily, the tilt angle of the elastic baffle plate 340 relative to the horizontally arranged body 3000 is 45°, 60°, 70°, 80°, 90°, 100°, or an intermediate value between any two values. The tilt angle is a tilt angle of the part of the baffle plate higher than the top end of the groove wall 302 in the natural state, and generally refers to an angle between a line connecting the top end and bottom end of this part and the top surface of the louver blade 300.

In some embodiments of the present disclosure, a sectional shape of the elastic baffle plate 340 is linear or annular in the natural state.

Unless otherwise specified, a section in the embodiments of the present disclosure refers to a section perpendicular to the length direction. Exemplarily, the section of the elastic baffle plate 340 can be in a straight-line shape, a curved-line shape, or other linear shape, or can be in an annular shape, or other frame shapes.

In some embodiments of the present disclosure, a material of the elastic baffle plate 340 includes at least one of rubber, silicone, PVC, elastomer TPE, TPR plastic, and polyurethane.

In the embodiment of the present disclosure, an installation position of the elastic baffle plate 340 on the groove wall 302 is the inside, the top or the outside of the groove wall 302, which is not specifically limited. In some embodiments of the present disclosure, the bottom end of the elastic baffle plate 340 is snapped or bonded to the groove wall 302. As one embodiment, the bottom end of the elastic baffle plate 340 passes through the groove wall 302 and is snapped to the inside wall of the drainage groove.

In some embodiments of the present disclosure, the elastic baffle plate 340 is arranged continuously or intermittently along a length direction of the body 3000.

The maximum length of the elastic baffle plate 340 that can extend into the drainage groove is not larger than the width of the narrowest position in the drainage groove, The elastic baffle plate 340 will deform under the action of the external force, and can extend into the drainage groove or be outside the drainage groove. When the louver blade 300 is in the closed state, the elastic baffle plate 340 is stressed to deform and extend into the drainage groove. In some embodiments of the present disclosure, the maximum length of the elastic baffle plate 340 that can extend into the drainage groove after deformation is smaller than or equal to the width of the narrowest position in the drainage groove, so as to ensure that the external force on the elastic baffle plate 340 is withdrawn after the louver blade 300 opens, so that it can restore to the natural state and be higher than the top end of the groove wall 302, thereby playing the function of drip-proof.

Based on the above technical solution, the body 3000 can meet at least one of the following conditions.

In some embodiments of the present disclosure, referring to FIG. 1, the body 3000 is made of a metal sectional material, and its section is a frame structure, wherein the frame structure is provided with a broken bridge structure therein. Two ends of the body 3000 are provided with removable sealing plates, and the sealing plates are used to seal the ends of the body 3000.

As one embodiment, a bottom of one side of the body 3000 extends outwardly to form a groove bottom; the groove bottom bends and extends upwardly to form the groove wall 302; the body 3000, the groove bottom, and the groove wall 302 form the drainage groove together; the drainage groove has a flow guide opening with an opening facing upward; and the flow guide opening is not higher than the top surface of the body 3000. The width of the narrowest position in the drainage groove (i.e. the width of the flow guide opening) is 20-100 mm, optionally 30-50 mm. Exemplarily, the width of the narrowest position in the drainage groove is 20 mm, 30 mm, 40 mm, 50 mm, 60 mm, 80 mm, or 100 mm, optionally 30-50 mm or an intermediate value between any two values.

In some embodiments of the present disclosure, the top of the groove wall 302 has a flange 303 extending toward an interior of the drainage groove, wherein the flange 303 is arranged horizontally or tends to warp upwardly towards its free end, and the elastic baffle plate 340 is arranged on the flange 303 or adjacent to the flange 303.

In some embodiments of the present disclosure, a downwardly extending waterproof edge 301 is arranged on the other side of the body 3000 relative to the drainage groove, and a bottom end of the waterproof edge 301 is lower than the top end of the groove wall 302, wherein the waterproof edge 301 of the louver blade 300 can press the elastic baffle plate 340 of the adjacent louver blade 300 and switch it to the stressed state.

Referring to FIG. 1-FIG. 4 specifically, in the embodiment, the body 3000 includes a frame body 300a and an extended edge part. The section of the frame body 300a is trapezoidal, and can be rectangular or other shapes in other embodiments. The interior of the frame body 300a is mostly hollow, which reduces the weight of the louver blade 300 product. Two sides of the upper surface of the frame body 300a extend outwardly in the horizontal direction respectively, so as to form the above extended edge part. Specifically, the extended edge part includes a first extension edge 300b located on the left side of the frame body 300a and a second extension edge 300c located on the right side of the frame body 300a.

The sealing plates are sealed on two ends of the frame body 300a by conventional manners such as the glue or screws. The waterproof edge 301 is arranged on one side of the first extension edge 300b away from the frame body 300a, and the lower end of the waterproof edge 301 extends a certain distance towards a direction of the bottom of the louver blade 300. A curved edge (groove bottom+groove wall 302) is integrally molded on a bottom of the other side of the frame body 300a; the drainage groove is formed between the curved edge and the right side surface of the body 3000; and the flow guide opening communicating the drainage groove is formed between the top end of the groove wall 302 and the second extension edge 300c, wherein the height of the drainage groove is lower than the height of the top surface of the louver blade 300, i.e., the height of the flow guide opening is lower than the height of the top surface of the louver blade 300. The top end of the groove wall 302 is lower than the height of the bottom of the second extension edge 300c. Referring to FIG. 2 and FIG. 3, when the adjacently arranged first louver blade 350 and the second louver blade 360 are in the closed state, the first extension edge 300b of the second louver blade 360 can overlap on the top end of the groove wall 302 of the first louver blade 350, and at the same time the waterproof edge 301 of the second louver blade 360 correspondingly extends into the flow guide opening of the first louver blade 350. The rainwater will enter into their own drainage groove after falling on the louver blade 300, and then the rainwater will be converged and discharged overall by the drainage groove. The above design can effectively prevent the rainwater from entering the viewing shelter via the gap between adjacent louver blades 300, thereby improving the waterproof sealing performance of the louvered shelter.

In order to improve the water storage and waterproof ability of the drainage groove, in the embodiment, the top of the groove wall 302 has a flange 303 extending in a direction facing the frame body 300a. The flange 303 is arranged horizontally, and the size of the flow guide opening can be controlled by the arrangement of the flange 303, which avoids that turbulence splashes out from the flow guide opening when the rainwater flows inside the drainage groove since the flow guide opening is too large. Meanwhile, it is also convenient to cooperate with the waterproof edge 301 by the arrangement of the flange 303, so that the waterproof edge 301 can extend into the flow guide opening when the adjacent louver blades 300 are arranged horizontally; and the lower end of the waterproof edge 301 extends to the lower end of the flange 303, so that it reduces the risk of rainwater entering into the viewing shelter via the gap between the waterproof edge 301 and the flange 303 when the rainwater on the upper end of the louver blades 300 enters into the interior of the flow guide opening via the waterproof edge 301, thereby improving the waterproof sealing performance between adjacent louver blades 300.

In the embodiment, the elastic baffle plate 340 is arranged on the flange 303 arranged horizontally. The elastic baffle plate 340 is made of polymethylmethacrylate (PMMA), wherein the sectional shape is a straight line, and the bottom end is snapped to the upper surface of the flange 303; a tilt angle of the elastic baffle plate 340 relative to the horizontally arranged body 3000 is 60°; and the top end of the elastic baffle plate 340 is 20 mm higher than the same-side edge of the top surface of the louver blade 300. Referring to FIG. 4, when the first louver blade 350 and the second louver blade 360 arranged adjacent to each other are in the open state, the first louver blade 350 and the second louver blade 360 have a spacing therebetween, wherein the elastic baffle plate 340 on the first louver blade 350 is in the natural state, and the first louver blade 350 has the drip-proof effect. The residual water droplet on the top surface of the first louver blade 350 will drip into the drainage groove in the direction shown by the arrow under the blocking effect of the elastic baffle plate 340 thereon. Similarly, the second louver blade 360 also has the drip-proof effect, wherein the water droplet thereon will drip into the drainage groove in the direction shown by the arrow and will not drip into the lower part of the louver blade 300.

In some embodiments of the present disclosure, in order to further improve the connection sealing performance between adjacent louver blades 300 when the louver blades 300 are in the closed state, the sealing strip is arranged on at least one side of the body 3000, wherein the sealing strip is located on the upper surface of the groove wall 302 or located on the lower surface of the other side of the body 3000 relative to the drainage groove, so as to close and seal the gap between the waterproof edge 301 and the flange 303 of the adjacent louver blades 300 when the plurality of louver blades 300 are arranged horizontally; and the position of the lower surface of the body 3000 close to the waterproof edge 301 and/or the upper surface of the flange 303 is provided with the sealing strip. As one embodiment, the lower surface of the body 3000 close to the waterproof edge 301 is provided with a snapping groove 304, wherein the snapping groove 304 extends along the length direction of the body 3000, and the sealing strip is snapped in the snapping groove 304.

In the embodiment, referring to FIG. 2 and FIG. 3, the sealing strips are arranged at the bottoms of their first extension edges 300b of the first louver blade 350 and the second louver blade 360, at which time the snapping groove 304 can be arranged at the bottom of the first extension edge 300b along its length direction, and then the sealing strip is snapped on the snapping groove 304 to facilitate the disassembling and assembling for the sealing strip, wherein the sealing strip can be the existing conventional rubber strip. When the first louver blade 350 and the second louver blade 360 are in the closed state, the sealing strip at the bottom of the first extension edge 300b of the second louver blade 360 will be bonded to the flange 303 of the first louver blade 350, which achieves a double sealing effect in conjunction with the deformed elastic baffle plate 340 on the first louver blade 350, thus improving the sealing waterproof performance at the overlapping and bonding position between the first louver blade 350 and the second louver blade 360. In other embodiments, the sealing strip can also be omitted, and the sealing effect can be achieved by using the elastic baffle plate 340; or the double sealing effect can be achieved by providing the sealing strip at the upper surface of the flange 303 in conjunction with the deformed elastic baffle plate 340 at the same time.

In some embodiments of the present disclosure, the solar panel 310 is further installed and arranged on the body 3000, and the top surface of the louver blade 300 is consisted of an upper surface of the solar panel 310. In some other embodiments, the top surface of the body 3000 is a continuous surface and is not provided with the solar panel 310, wherein the top surface of the louver blade 300 is consisted of the continuous surface.

As an optional method, in the embodiment, the louver blade 300 includes the solar panel 310. During the daytime, the energy generated by the solar panel 310 is stored in a storage battery after the energy conversion by an inverter or other components, which in turn supplies power to electrical devices in the viewing shelter. The body 3000 is provided with a holding groove for installing the solar panel 310, and the solar panel 310 is snapped into the holding groove. Specifically, the first extension edge 300b and the second extension edge 300c are separately bent upwardly to form the holding groove. As another optional method, the solar panel 310 is removably installed on the body 3000 by fasteners.

### Embodiment 2

Referring to FIG. 5-FIG. 8, the embodiment provides a louver blade 300, which differs from the louver blade 300 of the Embodiment 1 in that the flange 303 of the louver blade 300 tends to warp upwardly towards its free end; the waterproof plate is tilted towards the direction of the body 3000; the elastic baffle plate 340 is arranged on the flange 303; the bottom end of the elastic baffle plate 340 passes through the flange 303 to be fixed to the flange 303; a tilt angle of the elastic baffle plate 340 relative to the horizontally arranged body 3000 is 60°; and the top end of the elastic baffle plate 340 is 10 mm higher than the same-side edge of the top surface of the louver blade 300.

Referring to FIG. 6 and FIG. 7, when the first louver blade 350 and the second louver blade 360 arranged adjacent to each other are in the closed state, the first extension edge 300b of the second louver blade 360 can overlap on the flange 303 of the first louver blade 350. The waterproof edge 301 of the second louver blade 360 correspondingly extends into the flow guide opening of the first louver blade 350 at the same time, and the elastic baffle plate 340 is pressed to deform and extends into the drainage groove. The warped flange 303 of the first louver blade 350 and the inclined waterproof edge 301 of the second louver blade 360 interact with each other, which has a good pressing effect on the elastic baffle plate 340 on the first louver blade 350, so that the elastic baffle plate 340 exerts a better sealing effect; and the part of the elastic baffle plate 340 extending into the drainage groove is tilted, which has a better effect of blocking water in the drainage groove.

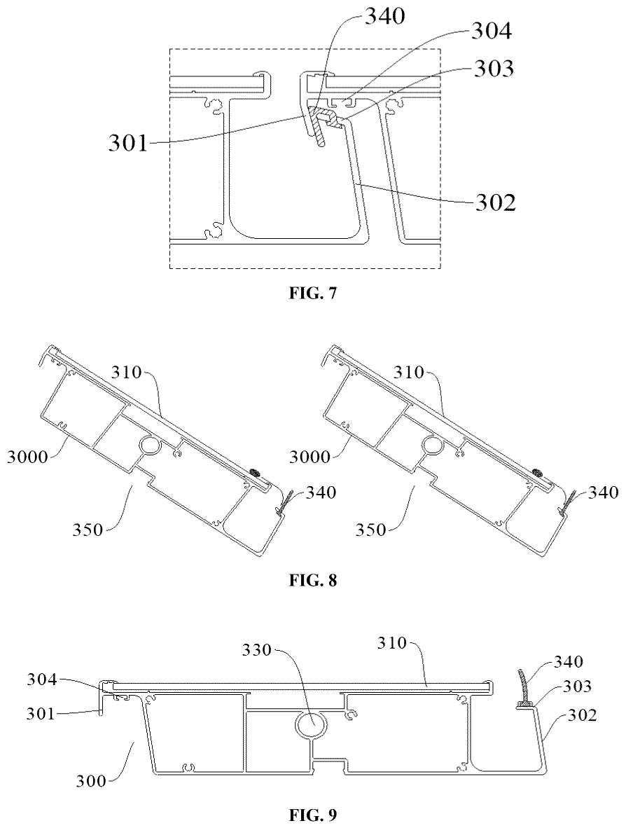

Referring to FIG. 8, when the first louver blade 350 and the second louver blade 360 arranged adjacent to each other are in the open state, the first louver blade 350 and the second louver blade 360 have a spacing therebetween. The elastic baffle plate 340 on the first louver blade 350 is in the natural state, and the first louver blade 350 has the drip-proof effect. Since the flange 303 of the first louver blade 350 warps upward, the protruding height of the above elastic baffle plate 340 is relatively larger, which achieves a better drip-proof effect. After the first louver blade 350 rotates by a larger angle towards the direction of the drainage groove, the residual water droplet on the top surface of the first louver blade 350 will drip into the drainage groove along the direction shown by the arrow under the blocking action of the elastic baffle plate, and is not easy to drip below the first louver blade 350.

### Embodiment 3

Referring to FIG. 9, the embodiment provides a louver blade 300, which differs from the louver blade 300 of the Embodiment 1 in that the section of the elastic baffle plate 340 is of an arcuate shape and is tilted, wherein the elastic baffle plate 340 of this form is easy to deform and extend into the drainage groove under the pressure of the adjacent louver blade 300, and is easy to return to the natural state, so as to play the role of drip-proof.

### Embodiment 4

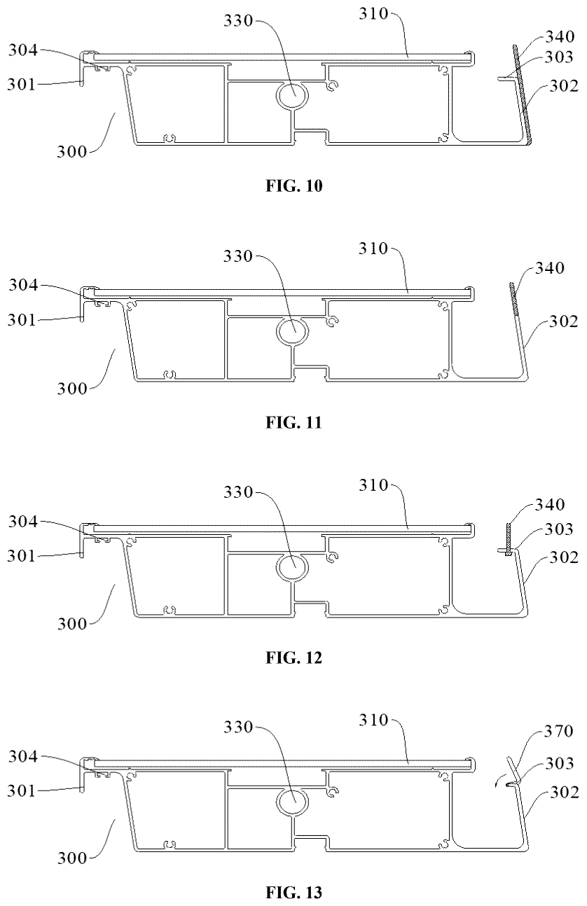

Referring to FIG. 10, the embodiment provides a louver blade 300, which differs from the louver blade 300 of the Embodiment 1 in that the elastic baffle plate 340 is arranged outside the drainage groove and specifically on the outer surface of the groove wall 302, wherein it can be fixed to the surface of the groove wall 302 by bonding, and the flange 303 is installed without destroying the sectional material structure of the body 3000. The tilt manner of the elastic baffle plate 340 is the same as that of the groove wall 302, and exerts the drip-proof effect in a similar way, which will not be repeated.

### Embodiment 5

Referring to FIG. 11, the embodiment provides a louver blade 300, which differs from the louver blade 300 of the Embodiment 1 in that the top end of the groove wall 302 is not provided with the flange 303, and the top end of the groove wall 302 is provided with the elastic baffle plate 340, wherein the elastic baffle plate 340 extends upwardly along the groove wall 302 to form a flat sidewall structure, so that it is difficult for the user to perceive the existence of the elastic baffle plate 340, and it does not affect the drip-proof function.

### Embodiment 6

Referring to FIG. 12, the embodiment provides a louver blade 300, which differs from the louver blade 300 of the Embodiment 1 in that the elastic baffle plate 340 is vertically arranged on the flange 303, and the tilt angle relative to the horizontally arranged body 3000 is 90°, wherein the bottom end of the elastic baffle plate 340 passes through the flange 303 to be fixed to the flange 303, and the top end of the elastic baffle plate 340 is flush to the same-side edge (the second extension edge 300c) of the top surface of the louver blade 300. The groove wall 302 is heightened by the elastic baffle plate 340, so that the drip-proof function can still be exerted when the louver blade 300 rotates at a smaller angle.

### Embodiment 7

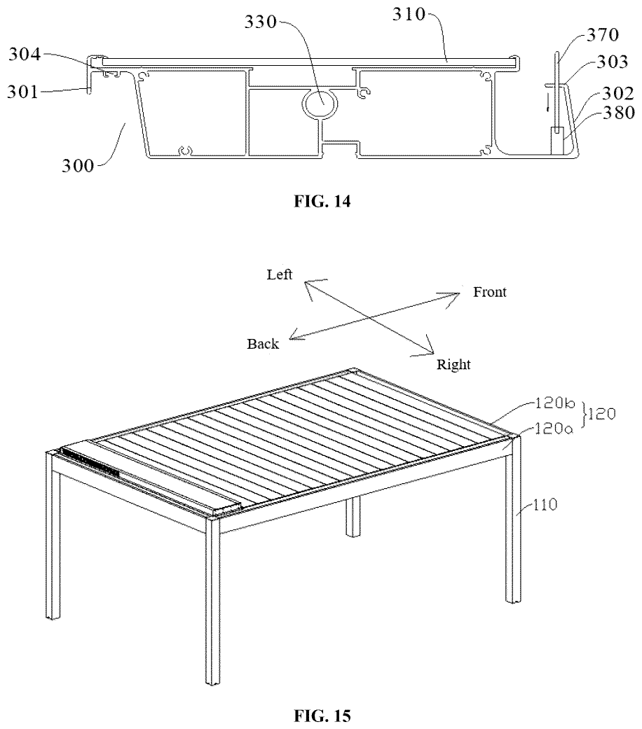

Referring to FIG. 13, the embodiment provides a louver blade 300, which differs from the louver blade 300 of the Embodiment 1 in that the baffle plate is a hard baffle plate 370, and the hard baffle plate 370 is hinged to the groove wall 302, wherein the hard baffle plate 370 can rotate around the hinge position to reduce the height of the top end in the stressed state, and the hard baffle plate 370 can switch to the natural state when the louver blade 300 rotates towards one side of the drainage groove. The hard baffle plate 370 is arranged on the top end of the groove wall 302 and hinged to the top end of the groove wall 302. Specifically, the section of the hard baffle plate 370 is in an L-shape; the transverse end portion of the hard baffle plate 370 is hinged to the end of the flange 303; and the flange 303 provides a supporting effect to the hard baffle plate 370. When the hard baffle plate 370 is subjected to a pushing force (the pressure provided by the flange of the adjacent louver blade), the hard baffle plate 370 can rotate around the hinge position to the stressed state according to the direction of the arrow as shown in the figure. When the louver blade 300 rotates towards one side of the drainage groove, the hard baffle plate 370 can switch to the natural state under its own gravity. In other embodiments, a reset member may further be arranged between the hard baffle plate 370 and the body 3000, and it can be a torsion spring, a tension spring, a pressure spring, or an elastic plate according to different installation positions. For example, a torsion spring is directly arranged at the hinge position, wherein the hard baffle plate 370 can switch to the natural state under the action of the reset member, so as to improve the stability when switching from the stressed state to the natural state.

In other embodiments, the material of the hard baffle plate 370 can adopt the same metal as the body, or adopt other hard materials. The installation position and method of the hard baffle plate 370 can also be in other ways, wherein the tilt angle and shape of the hard baffle plate 370 refers to the tilt angle and shape of the vertical part of the hard baffle plate 370, which can be arranged in the same method as the elastic baffle plate 340 in the Embodiment 1. When providing the hard baffle plate 370, it needs to notice that it will not completely cover the drainage groove when switching to the stressed state. Specifically, the length of the vertical part of the hard baffle plate 370 cannot be too large.

### Embodiment 8

Referring to FIG. 14, the embodiment provides a louver blade 300, which differs from the louver blade 300 of the Embodiment 1 in that the baffle plate is the hard baffle plate 370; the hard baffle plate 370 is connected to the drainage groove by the reset member 380; and the hard baffle plate 370 can move in its height direction to reduce the height of its top end under the stressed state, wherein the reset member can drive the hard baffle plate 370 to switch to the natural state. In the embodiment, the hard baffle plate 370 passes through the flange 303 on the top of the groove wall 302, and the bottom end of the hard baffle plate 370 extends into the drainage groove and is connected to the drainage groove by the reset member 380 (e.g. the pressure spring), wherein the reset member 380 can be provided in a number of one or more arranged at different sites. When the hard baffle plate 370 is subjected to a pressure (the pressure provided by the flange of the adjacent louver blade), the hard baffle plate 370 can rotate downwardly to the stressed state according to the direction of the arrow shown in the figure. When the external force is withdrawn, the hard baffle plate 370 can restore to be the natural state under the action of the reset member 380.

### Embodiment 9

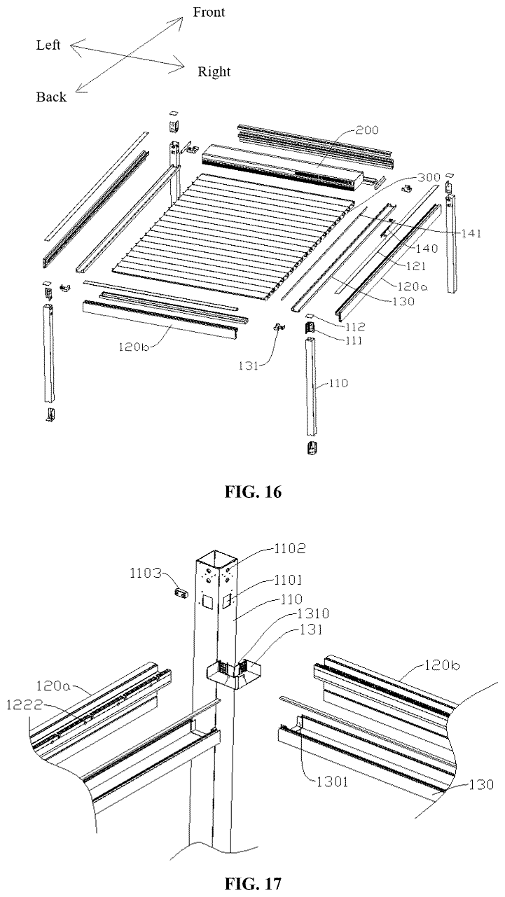

Referring to FIG. 15 and FIG. 16, the embodiment provides a viewing shelter including columns and the louvered roof, wherein the louvered roof is arranged on the top of the columns. The louvered roof includes the shelter frame and a plurality of louver blades 300 described in the foregoing embodiments, wherein two ends of the louver blade 300 are rotationally connected within the shelter frame respectively, and the plurality of louver blades 300 are distributed side by side on the shelter frame, wherein when the plurality of louver blades 300 are in the closed state on the shelter frame, the other side of one of the louver blades 300 relative to the drainage groove presses against the baffle plate 340 of the adjacent louver blade 300, so that the baffle plate 340 switches into the stressed state; and when the louver blades 300 rotate to the open state, the baffle plate 340 of the louver blade 300 switches into the natural state.

In the embodiments of the present disclosure, as an outdoor furniture for enjoying the sunbath, the viewing shelter generally includes the louvered roof, the columns for supporting the roof, and the electrical devices such as an air conditioner installed in the viewing shelter. The air conditioner 200 is installed on a shelter frame, and the shelter frame is of a rectangular structure overall and includes four beams 120 surrounding to form a rectangular shape, wherein the four beams 120 form roof space to accommodate the plurality of louver blades 300, and the ends of the two adjacent beams 120 are connected to the column 110. For ease of description, the two beams 120 located in the front-to-back direction (the front-to-back direction is also the length direction of the shelter frame) are referred to as the long beams 120a, and the two beams 120 located in the width direction (the width direction is also the right-to-left direction in the figure) are referred to as the short beams 120b. The plurality of louver blades 300 are distributed in linear at intervals in the length direction of the shelter frame; the left and right ends of the louver blades 300 are sealed by the sealing plates 320; a plug 330 is arranged at the center position of the sealing plates 320; and the plug 330 is rotationally inserted in one side of the long beam 120a, so that the louver blade 300 can swing on the shelter frame surrounding the plug 330, and thus the louvered roof opens when the plurality of louver blades 300 are tilted to rotate simultaneously. When the plurality of louver blades 300 rotate to the horizontal position, side edges of adjacent louver blades 300 bond with each other, thereby closing the louvered roof.

In one possible embodiment, the louvered roof further includes a linkage mechanism, and the linkage mechanism includes a linear telescopic rod and a linkage bar, wherein one end of the plurality of louver blades 300 are hinged to the linkage bar; one end of the linear telescopic rod is hinged to the shelter frame; and the other end is hinged to the linkage bar, so as to drive the plurality of louver blades 300 to rotate around hinge points of the louver blades 300 and the shelter frame after actuating the linkage bar to move.

In the embodiment, the simultaneous rotation and swing between the plurality of louver blades 300 can be achieved by the linkage mechanism. Specifically, the linkage mechanism includes a linkage bar 141 and a linear telescopic rod 140 arranged on one ends of the plurality of louver blades 300, wherein the linkage bar 141 is hinged to the bottom edge of the sealing plate 320 by a pin, and the pin is located at the lower end of the plug 330; one end of the linear telescopic rod 140 is hinged to the long beam 120a, and the other end is hinged to the linkage bar 141 for driving the linkage bar 141 to move. When it needs to adjust the arrangement angle of the plurality of louver blades 300, after the linear telescopic rod 140 telescopically drives the linkage bar 141 to move along the front-to-back direction of the shelter frame, the linkage bar 141 is utilized to drive the louver blades 300 to rotate on the long beam around the plug 330, so that the angle of the louver blades 300 is adjustable.

In the embodiments of the present disclosure, the downwardly extending waterproof edge 301 is arranged on the other side of the body 3000 of the louver blade 300 relative to the drainage groove. When the louver blade 300 is arranged horizontally, the bottom end of the waterproof edge 301 is lower than the top end of the groove wall 302. When the plurality of louver blades 300 are in the closed state, the waterproof edge 301 of one of the louver blades 300 is correspondingly inserted into the drainage groove of the adjacent louver blade 300. When the plurality of louver blades 300 are in the closed state, the other side of one of the louver blades 300 relative to the drainage groove presses against the elastic baffle plate 340 of the adjacent louver blade 300, so that the elastic baffle plate 340 extends into the drainage groove.

The above embodiments document the waterproof and flow guiding method between the side surfaces of the adjacent louver blades 300, and the following describes the overall flow guiding and drainage structure of the viewing shelter in conjunction with the specific installation relationships in the components of the column 110, the beam 120, and the louver blades 300 of the viewing shelter.

Referring to FIG. 19 and FIG. 20, the long beam 120a and the short beam 120b are of the same structure, and both include the side frame 1201, the beam cover 121, and the extension frame 122 arranged on the upper end of one side of the side frame 1201. The extension frame 122 is provided with a separator plate dividing the interior into a cabling groove 1221 and a preconnected cavity 1222, wherein the cabling groove 1221 is provided with an opening on the top of the extension frame 122, and one end of the opening is provided with a first snap-fit groove 1223. One end of the end cover 112 is provided with the first snapping head 121a that can be snapped in the first snap-fit groove 1223, and the other end of the end cover 112 is provided with the second snapping head 121b, wherein one end of the end cover 112 is snapped in the first snap-fit groove 1223 via the first snapping head 121a, and the other end is arranged on the other side of the opening, so as to connect to the side frame 1201.

In the embodiment, the side surface of the extension frame 122 is provided with an axis hole 122a and a wire groove, and the plugs arranged on two ends of the louver blade 300 are correspondingly inserted in the axis holes 122a, so that the louver blade 300 and the beam 120 are rotationally connected, and the wire groove is convenient for the routing.

In one possible embodiment, the drainage channel is arranged below same end of all the louver blades 300, and the drainage channel is provided with the water collecting opening towards the end of the louver blades 300, and the drainage channel is snapped to the shelter frame.

In the embodiment, the viewing shelter further includes the drainage channel 130, the drainage channel 130 is of a U-shaped structure overall, one side of which is provided with a third snapping head 1301, and the other side of which extends horizontally toward the interior of the roof space; and the U-shaped opening part is used to receive the rainwater converging from the two ends of the louver blade 300. The drainage channel 130 and the extension frame 122 are snapped in the second snap-fit groove 1201a of the side frame 1201 by the third snapping head 1301, so as to detachably snap to the side frame 1201.

Specifically, in order to facilitate the disassembly and assembly between the beam cover 121 and the beam 120 and the disassembly and assembly between the drainage channel 130 and the beam 120, referring to FIG. 20, the cooperation method and structure between the first snapping head 121a and the first snap-fit groove 1223 is the same as the cooperation method and structure between the third snapping head 1301 and the second snap-fit groove 1201a. Taking the structure of the third snapping head 1301 as an example, the third snapping head 1301 includes a bending head part 1301a and an abutting part 1301b, wherein the vertical section of the bending head part 1301a is of a convex curved structure, and the abutting part 1301b is arranged on the lower side of the head 1301a. The top of the second snap-fit groove 1201a is provided with a fitting foot 1201b. When the third snapping head 1301 is snapped to the interior of the second snap-fit groove 1201a, the curved part of the bending head part 1301a is correspondingly snapped to the fitting foot 1201b, and at the same time, the end part of the abutting part 1301b abuts against the bottom of the second snap-fit groove 1201a. It facilitates the disassembling and assembling of the corresponding components through the assembling between the above snapping head and the snap-fit groove. Through the cooperation of the curved part of the bending head part 1301a with the corresponding fitting foot 1201b of the snap-fit groove, it can quickly realize the pre-connection for the corresponding components; and then the abutting part 1301b is used to abut against the bottom of the snap-fit groove, so as to restrict the separation of the snapping head from the snap-fit groove in the vertical direction. For some wall-mounted components, such as the drainage channel 130, and the wall-mounted air conditioner, the drainage channel 130 can be stably fixed to the beam 120 by the weight of the product. Compared to some elastically snapping installation methods, the connection method between the snapping head and the snap-fit groove in the embodiment is more convenient for the disassembling and assembling of the corresponding products.

Based on the above embodiment, referring to FIG. 17, the connection between the beam 120 and the column 110 can be fastened by bolts. Specifically, the column 110 is a hollow tubular structure, preferably a rectangular tube, wherein screw holes 1102 are arranged on the side surface of the corresponding long beam 120a and short beam 120b, and the opening is arranged at the upper end of the column 110. When installing, a right-angled screwdriver passes through the opening and inserts into the hollow part of the column 110, and then the bolt is fastened. The bolt can be hidden in this way, thereby improving the aesthetic degree for the appearance of the product.

Referring to FIG. 17, in order to further facilitate the connection between the column 110 and the beam 120, a pre-connector 1103 is additionally arranged on the screw joint position between the column 110 and the end of the beam 120, wherein the pre-connector 1103 is in clearance fit with the preconnected cavity 1222 on the beam 120 (referring to FIG. 20). One benefit effect is that the pre-connector 1103 can support the beam 120; and the other benefit effect is that the clearance fitting between the pre-connector 1103 and the preconnected cavity 1222 also plays a role of fool-proofing, which facilitate the pre-connection between the beam 120 and the column 110, and facilitate the subsequent operation performed by the right-angled screwdriver.

Further, in order to improve the connection stability between the beam 120 and the column 110, a reinforcing member 111 can also be additionally arranged inside the column 110, such as an angle iron, so to improve the connection stability between them. As for the position of opening of the upper end of the column 110, after the installation of the column 110 and the beam 120, the opening at the upper end of the column 110 can be sealed by the end cover 112, so as to avoid the rainwater from directly entering into the column 110.

The existing drainage method for the roof usually is that after the rainwater falls on the louvered roof, the rainwater directly flows from the roof via the side edges, so that the water flow surrounding the louvered roof is relatively dense. As for the viewing shelter and other some products with external walls, the external wall side of the product is watered by the rainwater from the roof, which is easy to retain pollutants such as soil and leaves in rainwater, thereby resulting in the pollution on exterior wall of the viewing shelter and other product. In order to overcome the above defects, the hollow columns 110 and the drainage channel 130 are communicated in the embodiment, and the columns 110 are used to intensively discharge the water flow. Specifically, the water outlet is arranged on the lower end or the side surface of the hollow column 110; the upper end of the side surface of the column 110 is communicated with the drainage channel 130 by the flow guide member 131; and the rainwater converged by the drainage channel 130 enters into the column 110 through the flow guide member 131, and is discharged intensively by the water outlet of the column 110, so that the rainwater can be directly discharged without passing through the side surface of the roof, and the exterior wall of the viewing shelter will not be polluted.

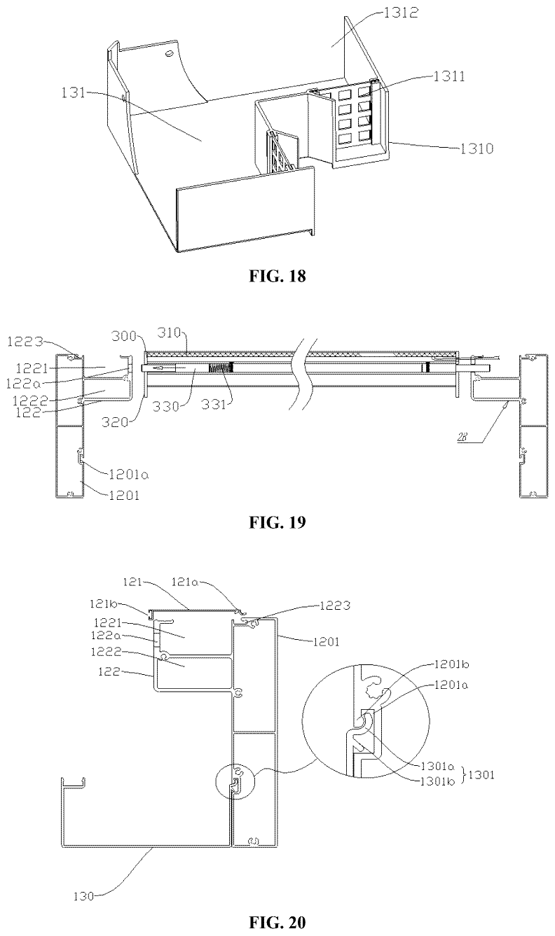

In the embodiment, referring to FIG. 17 and FIG. 18, in case that the shape of the column 110 is a cuboid, the shape on the side surface of the flow guide member 131 adapted to the side surface of the column 110 is an L-shaped notch. The entire cross section of the flow guide member 131 is of an L-shaped structure, wherein the interior is hollow, and the L-shaped notch part is correspondingly snapped to adjacent two sides of the column 110.

In the embodiment, the insertion member assembly includes a flow guide inserting member and a flow guide opening, wherein the flow guide inserting member includes a first insertion member 1302 and a second insertion member 1310, and the flow guide opening includes a first flow guide opening 1312 and a second flow guide opening 1101. Specifically, the second insertion member 1310 is arranged on one side of the binding surface between the flow guide member 131 and the column 110; the side of the flow guide member 131 provided with the second insertion member 1310 is in an opening state; the second flow guide opening 1101 is arranged at a position of the side surface of the column 110 corresponding to the second insertion member 1310, and the flow guide member 131 is inserted into the second flow guide opening 1101 by the second insertion member 1310, so that the interior of the flow guide member 131 is communicated with the interior of the hollow column 110. The first flow guide opening 1312 is arranged on the position of the other two sides of the flow guide member 131 corresponding to the drainage channel 130, and the end of the drainage channel 130 is provided with a first insertion member 1302 that can be inserted into the first flow guide opening 1312. By the above arrangement, after the first insertion member 1302 is inserted in the first flow guide opening 1312, the water flow in the drainage channel 130 is guided into the column 110 by the flow guide member 131, and is intensively discharged by the water outlet at the lower end of the column 110.

Based on the above embodiment, the above second insertion member 1310 is arranged on the flow guide member 131, and the second flow guide opening 1101 is arranged on the column 110. Of course, it can also be that the column 110 is provided with the second insertion member 1310 communicated with its interior, and the second flow guide opening 1101 is arranged on the flow guide member 131, which can also realize the above effect. It can be seen that the arrangement positions of the first insertion member 1302 and the first flow guide opening 1312 can also be interchanged on the drainage channel 130 and the column 110.

Further, in order to prevent impurities in the drainage channel 130 from entering into the column 110 and affecting the normal drainage of the column 110, a regulating member is arranged on the flow guide member 131, wherein the regulating member includes a filter gate 1311 arranged in the opening position of the flow guide member 131 close to the second insertion member 1310. The flow guide member 131 is provided with a slip groove on its inside wall, and the filter gate 1311 is movably inserted into the slip groove, so as to realize a detachable connection for the filter gate 1311. The plurality of through holes are arranged inside the filter gate 1311, wherein the water flow can flow into the column 110 via the through holes, and the impurities will be blocked in the drainage channel 130 by the filter gate 1311, so that the staff can clean the impurities by disassembling the drainage channel 130.

In the above embodiment, the filter gates 1311 are all provided with through holes, so that the rainwater will enter into the four columns 110 through the end of the drainage channel 130, and the four columns 110 can discharge water simultaneously at this time. Further, the regulating member can also be a sealing plate that the rainwater cannot pass through. It can be thought that through arranging the sealing plates at the different positions, i.e., the opening positions arranged for the water entering the flow guide member 131 from the drainage channel 130 is sealed by the sealing plates, it can limit the rainwater in the drainage channel 130 from entering into the column 110. Further, the water in the drainage channel 130 can be intensively discharged by the specific column 110 by utilizing the above features. The corresponding column 110 used for discharging water can be additionally provided with a waterproof, antirust and anti-corrosion coating on the inside wall, or the column 110 used for discharging water is made by the antirust and anti-corrosion materials with better waterproof performance, which can effectively reduce the production cost. The above features reduce the chance of the water seepage around the bottom of the viewing shelter or other shelters since the four columns 110 discharge water at the same time, which effectively improves the practicality and waterproof of the viewing shelter.

Based on the above embodiments, in order to facilitate the disassembly and assembly for the louver blade 300 on the long beam 120a, the plug 330 on the end of the louver blade 300 is provided to be telescopic. Specifically, at least one end of the body 3000 of the louver blade 300 is provided with a sliding hole for the plug 330 to slide inside, wherein the plug 330 can slide inside the sliding hole, and one end of the plug 330 located in the sliding hole is elastically connected to the end of the sliding hole by the elastic member 331, which can push the plug 330 out of the sliding hole, so that the louver blade 300 is connected into the axis hole 122a of the long beam 120a by the plug 330.

In the embodiment, the elastic member 331 can be a spring or other components made of the material with the elastic compression space, and the function is that when the louver blade 300 is installed between the two long beams 120a, the spring can be compressed by pressing the plug 330, wherein when the spring is compressed, the plug 330 can enter into the sliding hole. When the plugs 330 on two ends of the body 3000 are aligned with axis holes 122a arranged on the two long beams 120a, the plugs 330 are inserted into the axis hole 122a under the elastically resetting action of the spring, so that the louver blade 300 is rationally connected to the axis hole 122a on the long beam 120a.

Based on the above embodiments, in the embodiment, the air conditioner 200 is installed between the short beam 120b and the side edge of the louvered roof. The two sides of the air conditioner 200 are provided with mating grooves, and the one side of the air conditioner 200 is snapped to the second snapping head 121b arranged on the beam cover 121 by the mating groove, so that one side of the air conditioner 200 is snapped to the short beam 120b. Based on the above, the second snapping head 121b can also arranged on the side surface of the louver blade 300 adjacent to the air conditioner 200, so that the louver blade 300 is snapped to the air conditioner 200. The above solution facilitates quick installation between the air conditioner 200 and the short beam 120b, and at the same time, due to the self-weight of the air conditioner 200, one side of the second snapping head 121b of the beam cover 121 always has a vertically downward force, so that the first snapping head 121a on the other side of the beam cover 121 is snapped to the first snap-fit groove 1223 of the side frame 1201 more securely. The convenient installation between the air conditioner 200 and the beam cover 121 can also improve the connection stability between the beam cover 121 and the side frame 1201, i.e., it facilitates the installation of the air conditioner 200, and also improves the installation stability of the beam cover 121 on the side frame 1201, which is a two-in-one solution.

Based on the above embodiments, in order to improve the installation stability of the air conditioner 200, a reinforcement seat can also be additionally arranged between two ends of the air conditioner 200 and the long beam 120a, and in conjunction with the existing bolt fastening method, two ends of the air conditioner 200 and the long beam 120a are blocked, so as to improve the installation stability of the air conditioner 200 on the viewing shelter.

In summary, the louver blade, louvered roof, and viewing shelter in the embodiments of the present disclosure can reduce dripping water when rotating to open, thereby improving the user experience.

The foregoing is merely preferable embodiments of the present disclosure, and is not intended to limit the scope of the protection of the present disclosure. For those skilled in the art, the present disclosure may have various changes and variations. Any modifications, equivalent substitutions, improvements, etc. made within the spirit and principles of the present disclosure shall be included in the scope of protection of the present disclosure.

1. A louver blade, comprising a flaky body, wherein a drainage groove is arranged on one side of the body; the drainage groove comprises a groove wall located on an outer side of the body;
and a baffle plate is further arranged on a top of the groove wall, wherein when the body is arranged horizontally, a top end of the groove wall is not higher than a top surface of the louver blade, and the baffle plate can switch between a natural state and a stressed state, wherein a top end of the baffle plate in the natural state is higher than the top end of the groove wall, and a height of the top end of the baffle plate can be reduced in the stressed state.

2. The louver blade according to claim 1, wherein the baffle plate is an elastic baffle plate, and the elastic baffle plate can deform to reduce the height of the top end of the baffle plate in the stressed state.

3. The louver blade according to claim 2, wherein a sectional shape of the elastic baffle plate is linear or annular in the natural state.

4. The louver blade according to claim 1, wherein the baffle plate is a hard baffle plate, and the hard baffle plate is hinged to the groove wall, wherein the hard baffle plate can rotate around a hinge position under the stressed state to reduce the height of the top end of the baffle plate; and
the hard baffle plate can switch to the natural state when the louver blade rotates towards one side of the drainage groove.

5. The louver blade according to claim 4, wherein the hard baffle plate can switch to the natural state under an action of gravity when the louver blade rotates towards one side of the drainage groove; or, a reset member is arranged between the hard baffle plate and the body, and the hard baffle plate can switch to the natural state under an action of the reset member.

6. The louver blade according to claim 1, wherein the baffle plate is a hard baffle plate; the hard baffle plate is connected to the drainage groove by a reset member; and the hard baffle plate can move in a height direction of the baffle plate to reduce the height of the top end of the baffle plate under the stressed state, wherein the reset member can drive the hard baffle plate to switch to the natural state.

7. The louver blade according to claim 6, wherein the hard baffle plate passes through the groove wall, and a bottom end of the hard baffle plate extends into the drainage groove and is connected to the drainage groove by the reset member.

8. The louver blade according to claim 1, wherein the top of the groove wall has a flange extending toward an interior of the drainage groove, and the baffle plate is arranged on the flange or adjacent to the flange.

9. The louver blade according to claim 8, wherein the flange is arranged horizontally or tends to warp upwardly towards a free end of the flange.

10. The louver blade according to claim 8, wherein a downwardly extending waterproof edge is arranged on the other side of the body relative to the drainage groove, and a bottom end of the waterproof edge is lower than the top end of the groove wall, wherein the waterproof edge of the louver blade can press the baffle plate of an adjacent louver blade and switch the baffle plate to the stressed state.

11. The louver blade according to claim 1, wherein the top end of the baffle plate in the natural state is higher than a same-side edge of the top surface of the louver blade.

12. The louver blade according to claim 1, wherein a tilt angle of the baffle plate in the natural state relative to the top surface of the louver blade is 45°-100°.

13. The louver blade according to claim 1, wherein a bottom of one side of the body extends outwardly to form a groove bottom; the groove bottom bends and extends upwardly to form the groove wall; the body, the groove bottom, and the groove wall form the drainage groove together;
the drainage groove has a flow guide opening with an opening facing upward; and the flow guide opening is not higher than a top surface of the body.

14. The louver blade according to claim 2, wherein a maximum length of the baffle plate that can extend into the drainage groove in the stressed state is not larger than a width of a narrowest position in the drainage groove.

15. The louver blade according to claim 1, wherein the top end of the baffle plate in the natural state is 5-80 mm higher than the top end of the groove wall.

16. The louver blade according to claim 1, wherein the baffle plate is arranged continuously or intermittently along a length direction of the body.

17. A louvered roof, comprising a shelter frame and a plurality of louver blades according to claim 1, wherein two ends of the louver blade are rotationally connected within the shelter frame respectively, and the plurality of louver blades are distributed side by side on the shelter frame, wherein when the plurality of louver blades are in the closed state on the shelter frame, the other side of one of the louver blades relative to the drainage groove presses against the baffle plate of an adjacent louver blade, so that the baffle plate switches to the stressed state; and when the louver blades rotate to an open state, the baffle plates of the louver blades switch into the natural state.

18. The louvered roof according to claim 17, wherein a downwardly extending waterproof edge is arranged on the other side of the body of the louver blade relative to the drainage groove, wherein when the louver blade is arranged horizontally, a bottom end of the waterproof edge is lower than a top end of the groove wall; and when the plurality of louver blades are in a closed state, the waterproof edge of one of the louver blades is correspondingly inserted into the drainage groove of the adjacent louver blade.

19. The louvered roof according to claim 17, wherein the baffle plate is an elastic baffle plate, wherein when the plurality of louver blades are in the closed state, the other side of one of the louver blades relative to the drainage groove presses against the elastic baffle plate of the adjacent louver blade, so that the elastic baffle plate extends into the drainage groove.

20. A viewing shelter, comprising columns and the louvered roof according to claim 17, wherein the louvered roof is arranged on tops of the columns.
